(19) United States
(12) Patent Application Publication
(10) Pub. No.: US 2013/0291838 A1
(43) Pub. Date: Nov. 7, 2013

(54) Diesel bleeder

(71) Applicant: Ronnie Lee Booth, Chocowinity, NC (US)

(72) Inventor: Ronnie Lee Booth, Chocowinity, NC (US)

(21) Appl. No.: 13/464,057

(22) Filed: May 4, 2012

(51) Int. Cl. F02M 37/00

(52) U.S. Cl. 123/516

(57) ABSTRACT

An apparatus for bleeding diesel fuel powered engines and method for using same. One embodiment of the apparatus comprises a canister for containing pressurized fuel and having a means for attaching to and engaging with a fuel system. The apparatus may be connected to the inlet side of an engine's fuel filter and, when engaged, will push the fuel into the fuel system and air out of the system without having to separately bleed each injector within the engine.

### BACKGROUND OF INVENTION

Diesel engines require a steady, air-free flow of fuel in order to function properly. At times, this becomes a challenge. For example, air may be released into the engine if an engine runs out of fuel; repair or replacement is required of a fuel injector nozzle, injector pump, fuel filter, or the fuel line; or for various other reasons. When this occurs, it is necessary to bleed the fuel system, replacing the air with fuel so that the engine will function.

Some modern engines have self-bleeding fuel systems, but even these systems still require manual bleeding at times. Even the quickest self-bleeding systems still take some time, ranging from half an hour to several hours, since traditional methods require that each individual injector be separately bled. A large number of engines continue to be manufactured that are not self-bleeding as well as an even larger number of older engines still in use that do not have self-bleeding systems.

Many users of diesel powered machines do not have the knowledge or experience to bleed their fuel systems. When this becomes necessary, such a user must either bring a mechanic on site or arrange for the machine to be hauled to a mechanic. Even with knowledge of how to bleed a fuel system, accomplishing the actual task may take several hours.

In any event, bleeding a diesel engine usually is both an enormous inconvenience and also a significant waste of money in lost production time or mileage. At times, such as in military conflicts, taking the time to bleed a diesel engine can be dangerous as well as inconvenient. There is, thus, a long-felt need for a bleeder system that is fast, simple, and economical.

### SUMMARY OF INVENTION

The present invention relates generally to an apparatus and method for bleeding diesel fuel powered engines. The apparatus comprises a canister for containing pressurized fuel and having a means for attaching to and engaging with a fuel system. The apparatus may be connected to the inlet side of a fuel filter and, when engaged, will push the fuel into the fuel system and air out of the system without having to separately bleed each injector within the engine. The method generally comprises pressurizing, with air or another suitable gas, a container of fuel; opening the bleed screws of a diesel engine fuel system; and using the pressurized container to flush fuel through the fuel system, thereby driving air out of the fuel system without having to separately bleed each injector within the engine.

### BRIEF DESCRIPTION OF DRAWINGS

FIG. 1 depicts an exterior view of an embodiment of the inventive bleeder.

FIG. 2 shows a second embodiment of the inventive bleeder.

FIGS. 3A and 3B show a bleed valve for the inventive bleeder in the on and off positions.

FIGS. 4A and 4B depict the exterior and a cutaway view of the embodiment of the inventive bleeder depicted in FIG. 1.

### DETAILED DESCRIPTION

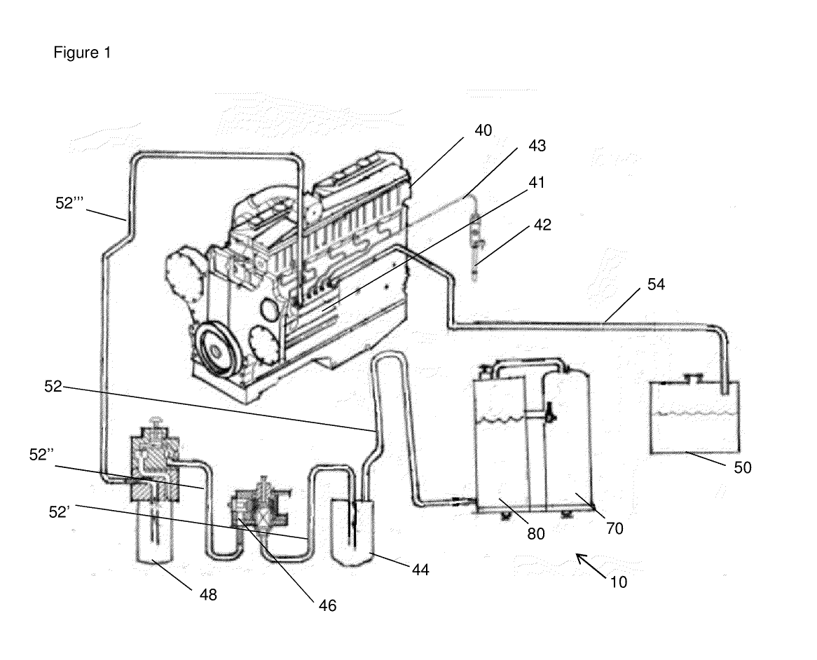

Certain embodiments of the novel bleeder 10 are described herein and depicted in FIGS. 1-4B.

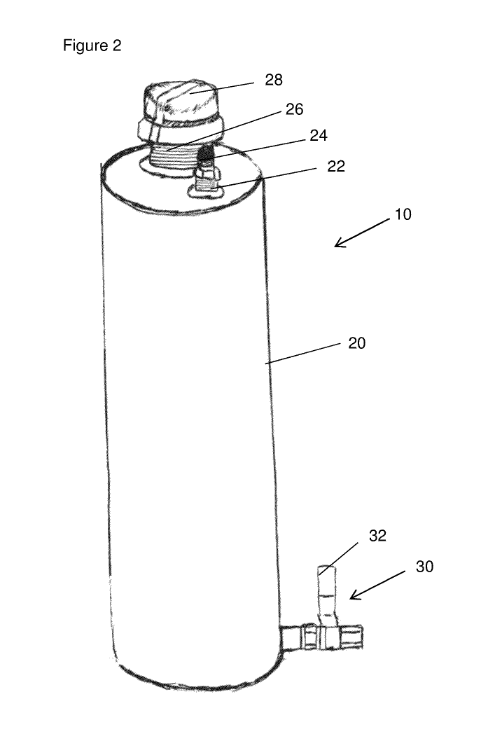

With reference to FIG. 2, bleeder 10 comprises a canister 20, having a fuel intake 26, an air intake valve 22, and a bleed valve 30. The canister 20 should be manufactured of a material that is safe for storing fuel under pressure. Such materials include aluminum and steel, though other materials may also be appropriate. The canister 20 should be of sufficient size to contain at least enough fuel to bleed the fuel lines of the engine requiring attention. The amount of fuel required will depend on the manufacture of the engine. Generally, engines in farm machinery and heavy duty commercial trucks only require no more than three quarts of fuel to bleed their fuel lines. If the canister 20 is large enough to contain more than the necessary amount of fuel, it may be used more than once to bleed an engine. While it is not necessary to the functionality of the bleeder 10, the user may prefer the convenience of an incorporated fuel gauge and/or an incorporated pressure gauge for the canister 20.

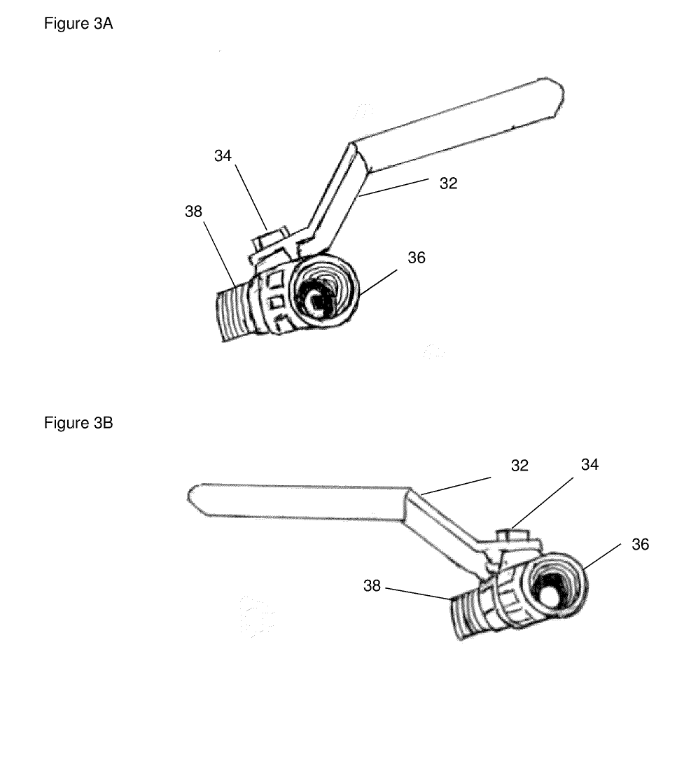

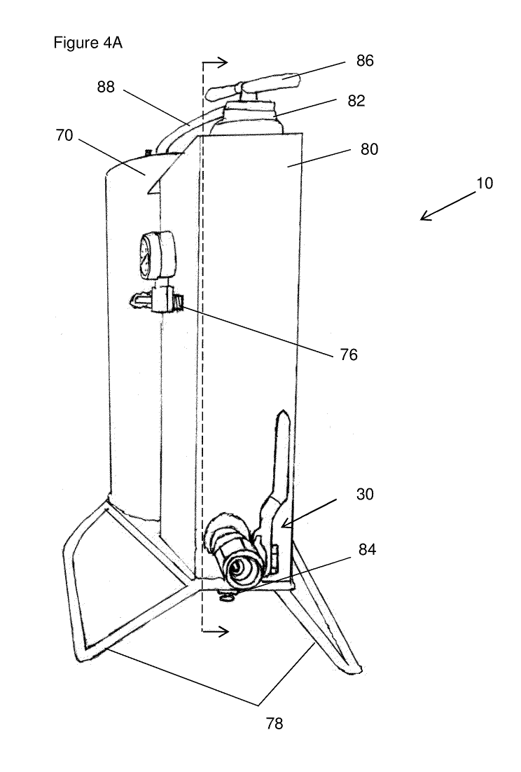

FIGS. 3A and 3B provide detailed views of the bleed valve 30. The bleed valve 30 comprises a connector 38 to connect the bleed valve 30 to the canister 20. The bleed valve 30 further comprises a handle 32 for turning on and off the flow of fuel from the canister 20 into the engine 40. The handle 32 may be a lever style handle as depicted or may instead be a bar handle, knob, switch, or any other means of controlling the flow of pressurized fuel through the bleed valve 30. The bleed valve 30 may further comprise a vent tube 34, which may be placed within the handle as is shown in the depicted embodiment, for directing excess fuel or air from system lines. The bleed valve 30 also comprises a bleed valve nozzle 36 for connecting the bleeder 10 to the primary fuel filter 44 of the engine 40.

In order to prepare for use the bleeder 10 as depicted in FIG. 2, a user should first ensure that the handle 32 of the bleed valve 30 is set in the off position (detailed drawings of the handle 32 in the on and off positions are shown in FIGS. 3A and 3B). Next, the user may remove the fuel cap 28 from the fuel intake 26 and partially fill the canister 20 with fuel of the type required for use by an engine requiring bleeding. To prepare the canister 20 for use, there must only be sufficient room remaining in the canister 20 to allow for pressurization. Once the user has filled the canister 20 with the desired amount of fuel, the user may replace the fuel cap 28 onto the fuel intake 26. The fuel cap 28 should achieve a secure fit with the fuel intake 26 such that it can withstand pressurization.

The user may then pressurize the canister by removing the cap 24 from the air intake valve 22 and attaching an air compressor (not shown) to the air intake valve 22. The user may press a hose fitting of the compressor down onto the stem of the air intake valve 22 and activate the compressor. The amount of air pressure required will depend on the manufacture of the engine requiring bleeding but must, in any event, be greater than the surrounding atmospheric pressure. Generally, a range of 12-18 psi should be sufficient for engines in farm machinery and heavy duty commercial trucks. Since this range of pressure is not dangerous, a pressure relief safety valve is not expected to be necessary, but incorporation of such a valve would be a useful addition. It should be noted that while the method of pressurizing the canister has been described with reference to air, and air is preferred for cost and safety reasons, pressurization could be achieved using any gas that would not be dangerous in combination with fuel and diesel engines. Preferably a substantially non-flammable gas that has been rated as non-flammable/non-toxic will be used; and pre-pressurized canisters of air or other gas may be utilized rather than attaching an air or other gas compressor.

With reference to FIG. 1, in order to use the bleeder 10 to bleed the fuel lines of an engine 40 from air, the user should first open the bleed screws (not shown) on top of the fuel filters 44, 48 as well as the bleed screws (not shown) on the fuel injection pump 41. (A “bleed screw” is a device used to create a temporary opening in an otherwise closed system, which facilitates the removal of air from the system.) Next, the user should connect the bleeder 10 to the primary fuel filter 44. Optionally, this may be accomplished by connecting the bleed valve nozzle 36 directly to the primary fuel filter 44 but alternatively a less direct attachment, such as to a supply fuel line 52 feeding the primary filter 44, may be utilized. The bleed valve nozzle 36 should be appropriately sized to fit with the inlet valve (not shown) on the primary fuel filter 44 or to the hose comprising the supply fuel line 52.

With reference to FIGS. 1-3B, when the bleeder 10 has been securely connected to the primary fuel filter 44, the user may turn the handle 32 on the bleed valve 30 to the “on” position, while preferably taking care to ensure that the vent tube 34 is directed away from the user as a safety precaution. The pressurized fuel flows from the canister 20 along the connector 38, through the bleed valve 30, into the supply fuel line 52 and through the primary fuel filter 44, supply fuel line 52′, transfer pump 46, supply fuel line 52″, secondary fuel filter 48, and supply fuel line 52′″, and then throughout the fuel injection pump 41 in the engine 40, replacing the air in each fuel injection line 43 and fuel injection nozzle 42 within the fuel injection pump 41 with fuel. The air will escape through the bleed screws, and any excess fuel will return to the fuel tank 50 by way of the fuel return line 54. The user may be able to hear the fuel replacing the air within the system, which is likely to take mere seconds. Of course, the time required for the bleeder 10 to purge trapped air depends on the length and size of fuel system lines between the tank and engine.

Once an air-free flow of fuel within the fuel lines is evident, the user should turn the handle 32 on the bleed valve 30 to the “off” position. The user may then close the bleed screws. The engine 40 should now be properly bled and ready for operation. The user may wish to refer to starting instructions in the owner's manual before attempting to start the engine after bleeding the fuel system.

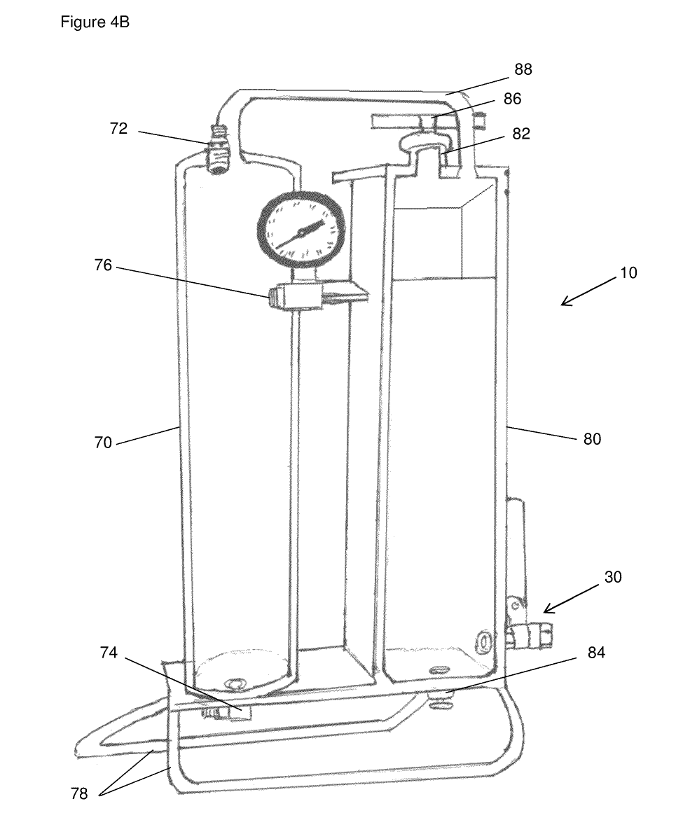

In certain embodiments of the inventive bleeder 10, an example of which is depicted in FIGS. 1, 4A, and 4B, the bleeder 10 may have two separate canisters 70, 80 for air and fuel. The air canister 70 may comprise an air intake valve 72 and an optional pressure gauge 76. The fuel canister 80 may comprise a fuel intake 82 and a bleed valve 30. The canisters 70, 80 may further comprise optional drains 74, 84 to allow a user to release water from the canisters 70, 80 in the event that condensation forms due to weather or temperature conditions. The canisters 70, 80 may be connected by means of a hollow carrying handle 88, which serves as both a handle and a tube to allow for transfer of the pressurized air into the fuel canister 80. In order to pressurize the fuel canister 80, a user may twist the handle 86 atop the fuel intake 82. This draws pressurized air from the air canister 70 into the fuel canister 80 by way of the hollow carrying handle 88 and through the air intake valve 72. The depiction of this embodiment of bleeder 10 further comprises an optional stand 78. As previously described, the bleeder 10 may then be connected to the fuel system of an engine 40 by engaging the bleed valve 30 to the primary fuel filter 44.

In certain embodiments of the inventive bleeder 10, the bleeder 10 may further include means to heat the bleeder 10. Diesel fuel contains wax that normally is liquid in the fuel but may solidify at lower temperatures, causing the fuel to become cloudy when temperatures drop, with little crystals of wax that may clog a fuel filter. In even lower temperatures, the fuel may gel so that it will not flow. The bleeder 10 may be equipped with a battery heater on the exterior of the canister or an in-tank fuel warmer.

The foregoing details are exemplary only. Other modifications that might be contemplated by those of skill in the art are within the scope of this invention, and are not limited by the examples illustrated herein.

I claim:

1. A bleeder for bleeding air from the fuel system of a diesel engine comprising
a. a canister for pressurized fuel, said canister comprising
i. a sealable fuel inlet and
ii. an air intake valve; and
b. a bleed valve connected to the canister, said bleed valve comprising
i. a flow control handle and
ii. a fuel outlet.

2. The bleeder of claim 1 in which the canister further comprises a pressure relief safety valve.

3. The bleeder of claim 1 in which the canister further comprises a fuel gauge.

4. The bleeder of claim 1 in which the canister further comprises a pressure gauge.

5. The bleeder of claim 1 in which the canister further comprises an in-tank fuel warmer.

6. The bleeder of claim 1 in which the canister further comprises a battery-powered heater.

7. A bleeder for bleeding air from the fuel system of a diesel engine comprising
a. a first canister, said canister comprising
i. a sealable air intake and
ii. an air vent;
b. a second canister, said canister comprising
i. a sealable fuel inlet and
ii. an air intake;
c. connector, said connector connecting the air vent of the first canister to the air intake of the second canister; and
d. a bleed valve connected to the canister, said bleed valve comprising
i. a flow control handle and
ii. a fuel outlet.

8. The bleeder of claim 7 in which the first canister further comprises a drain.

9. The bleeder of claim 7 in which the second canister further comprises a drain.

10. The bleeder of claim 7 in which the first canister further comprises a pressure relief safety valve.

11. The bleeder of claim 7 in which the second canister further comprises a pressure relief safety valve.

12. The bleeder of claim 7 in which the second canister further comprises a fuel gauge.

13. The bleeder of claim 7 in which the first canister further comprises a pressure gauge.

14. The bleeder of claim 7 in which the second canister further comprises a pressure gauge.

15. The bleeder of claim 7 in which the second canister further comprises an in-tank fuel warmer.

16. The bleeder of claim 7 in which the second canister further comprises a battery-powered heater.

17. A method for bleeding air from the fuel system of a diesel engine, said fuel system comprising a fuel filter and fuel lines, the method comprising:
a. pressurizing a container of fuel by pumping a gas into a container until pressure inside the container exceeds pressure of the surrounding atmosphere;
b. attaching the pressurized container of fuel to the fuel filter;
c. opening at least one bleed screw in the fuel system of the engine;
d. releasing fuel from the pressurized container of fuel into the fuel line feeding the fuel filter;
e. permitting fuel to flow into the fuel line feeding the fuel filter until fuel released through the at least one bleed screw is free of air bubbles;
f. terminating the flow of fuel from the pressurized container of fuel; and
g. closing the at least one bleed screw.

18. The method of claim 18 wherein the gas is air.

19. The method of claim 18 wherein the container is pressurized until the pressure inside the container exceeds 12 psi.
